(19) United States
(12) Patent Application Publication
(10) Pub. No.: US 2025/0119933 A1
(43) Pub. Date: Apr. 10, 2025

(54) MANAGING CROSS-LINK INTERFERENCE IN A WIRELESS COMMUNICATION NETWORK

(71) Applicants: CENTRE OF EXCELLENCE IN WIRELESS TECHNOLOGY, Tamil Nadu (IN); INDIAN INSTITUTE OF TECHNOLOGY MADRAS (IIT MADRAS), Tamil Nadu (IN)

(72) Inventors: Priyanka DEY, Tamil Nadu (IN); Abhijeet Abhimanyu MASAL, Tamil Nadu (IN); Deepak Padmanabhan MAYA, Tamil Nadu (IN); Jeniston Deviraj Klutto MILLETH, Tamil Nadu (IN); Bhaskar RAMAMURTHI, Tamil Nadu (IN)

(21) Appl. No.: 18/836,162

(22) PCT Filed: Feb. 6, 2023
(86) PCT No.: PCT/IN2023/050113

§ 371 Date: Aug. 6, 2024

(30) Foreign Application Priority Data
Feb. 7, 2022 (IN) 202241006434

(51) Int. Cl. H04W 72/541; H04L 5/00; H04W 24/10; H04W 72/21

(52) U.S. Cl. CPC H04W 72/541; H04L 5/0048; H04W 24/10; H04W 72/21

(57) ABSTRACT

A method for managing cross-link interference in wireless communication network is de-scribed. The method comprises receiving, by a first User Equipment (UE), information re-lated to a Reference Signal (RS), from a Base Station (BS). The information is at least one of a phase rotation and a number of repetitions in time domain. The first UE may generate the RS based on the information. The first UE may transmit the RS with a first timing ad-vance to a second UE. A method for reporting the cross-link interference in the wireless communication network is described. The method comprises receiving the RS by the first UE. The first UE may determine a parameter of the RS. The first UE detects occurrence of a trigger event and transmits a report based on the parameter. The report may be transmitted to the BS using a physical layer or a medium access control (MAC) layer.

### FIELD OF THE INVENTION

The present invention relates to communication between base stations and user equipments, and more particularly to managing cross-link interference between base stations and user equipments in a wireless communication network.

### BACKGROUND OF THE INVENTION

Wireless communication systems are widely deployed to provide various telecommunication services such as telephony, video, data, messaging, and broadcasting. Typical wireless communication systems may employ multiple-access techniques capable of supporting communication with multiple users by sharing the available system resources (e.g., bandwidth and transmit power). Examples of such multiple access techniques include: Long Term Evolution (LTE) systems, Code Division Multiple Access (CDMA) systems, Time Division Multiple Access (TDMA) systems, Frequency Division Multiple Access (FDMA) systems, Orthogonal Frequency Division Multiple Access (OFDMA) systems, Single Carrier Frequency Division Multiple Access (SC-FDMA) systems, and Time Division Synchronous Code Division Multiple Access (TD-SCDMA) systems.

New Radio (NR) technology is emerging as a next generation 5G standard, multiple features are being enhanced from a base NR version, to support wide range of devices. FIG. 1 illustrates a wireless communication system 100 for communication between base stations and user equipments, in accordance with prior-art. The wireless communication system 100 comprises a first Base Station (BS) 102 and a second BS 104. The first BS 102 is present adjacent to the second BS 104. The first BS 102 performs downlink with a first User Equipment (UE) 106 and the second BS 104 performs uplink with a second UE 108 in same time-frequency resources. A downlink signal transmitting from the first BS 102 may interfere with an uplink signal being received at the second BS 104. The interference between the first BS 102 and the second BS 104 or between the first UE 106 and the second UE 108 is referred as Cross-Link Interference (CLI). Performance of the second BS 104 and the first UE 106 may be degraded due to the CLI. Thus, there is a need of managing the CLI for measuring, reporting, and mitigating the interference between BSs and UEs.

Conventionally in the NR technology, CLI measurement is performed using Sounding Reference Signal (SRS). As illustrated in FIG. 1, the second UE 108 transmits a SRS symbol to the first UE 106. The first UE 106 shifts its receiving boundaries with a constant implementation specific offset. When a misalignment in receiving the SRS symbol is beyond a Cyclic Prefix (CP) duration, an accuracy of measured Reference Signal Received Power (RSRP) may be degraded.

FIG. 2 illustrates transmission and reception boundaries of the SRS symbol for UEs, in accordance with prior art. The second UE 108 transmits the SRS symbol in uplink with a Timing Advance (TA) of TA2. The first UE 106 receives the SRS symbol after a propagation delay of ‘t’. The first UE 106 knows a value of the constant implementation specific offset. Thus, the first UE 106 shifts its reception boundaries according to the constant implementation specific offset. Downlink reception boundaries of the first UE 106 and actual timing of reception of the SRS symbol may be misaligned due to the propagation delay ‘t’. A window within which the SRS symbol is to be processed after considering measurement time offset could be seen in FIG. 2. Information included in the SRS symbol is not lost when the misalignment between the actual timing of reception of the SRS symbol and the measurement time offset for SRS measurements is within the CP duration. However, the information included in the SRS symbol may be lost when the misalignment between the actual timing of reception of the SRS symbol and the measurement time offset for SRS measurements is not within the CP duration. Factors, such as synchronization errors, smaller CP length in higher numerologies, and higher propagation delay between the first UE 106 and the second UE 108 may cause the misalignment while measuring the CLI as the first UE 106 and the second UE 108 are not time synchronized. Loss of information included in the SRS symbol leads to inaccuracies in the SRS measurements.

The first UE 106 performs L3 reporting for informing details of the CLI to the first BS 102. The first BS 102 semi-statically configures the first UE 106 to perform L3 reporting of SRS-RSRP when the RSRP measured by the first UE 106 goes beyond a pre-defined threshold. Therefore, dynamic reporting and handling of the CLI may not be possible through L3 reporting. Further, L3 report provides information about time averaged CLI reflecting a long-term fading of a channel. However, the L3 report does not reflect the CLI due to dynamic scheduling of the first UE 106 and the second UE 108.

Thus, there is a need of a method for managing CLI in a wireless communication network, which addresses the above-mentioned shortcomings associated with conventional technique of managing the CLI.

### OBJECTS OF THE INVENTION

A general objective of the present invention is to provide a method of managing Cross-Link Interference (CLI) in a wireless communication network.

Another objective of the present invention is to provide a method of dynamic reporting of CLI measurement to a Base Station (BS).

Another objective of the present invention is to improve accuracy of CLI measurement.

### SUMMARY OF THE INVENTION

The summary is provided to introduce aspects related to management of cross link interference in a wireless communication network, and the aspects are further described below in the detailed description. This summary is not intended to identify essential features of the claimed subject matter nor is it intended for use in determining or limiting the scope of the claimed subject matter.

The present invention relates to a method for managing cross link interference in a wireless communication network. The method may comprise receiving, by at least one first node, information related to at least one Reference Signal (RS) from at least one second node. The information is at least one of a phase rotation and a number of repetitions in time domain. The method may further comprise generating, by the at least one first node, the at least one RS based on the information. The method may further comprise transmitting, by the at least one first node, the at least one RS with a first timing advance.

In an aspect, the at least one RS is a Sounding Reference Signal (SRS).

In an aspect, the phase rotation is configured such that time domain circularity is maintained over a plurality of consecutive time domain symbols in which the at least one RS is transmitted.

In as aspect, the information is received from the at least one second node, using Radio Resource Control (RRC) message.

In an aspect, the RRC message is transmitted as SRS-config Information Element (IE).

In an aspect, the at least one RS is repeated and transmitted in a same frequency resource over the plurality of consecutive time domain symbols without hopping.

In an aspect, the at least one second node indicates the at least one first node not to apply hopping for the at least one RS.

In an aspect, the hopping comprises at least one of sequence hopping, group hopping, and frequency hopping.

In an aspect, the method may further comprise indicating by one of the at least one second node and at least one fourth node, to at least one third node to not apply a constant offset value while measuring the at least one RS.

The present invention further relates to a method for reporting cross link interference in a wireless communication network. The method may comprise receiving, by at least one first node, at least one Reference Signal (RS). The method may further comprise measuring, by the at least one first node, at least one parameter of the at least one RS. The method may further comprise detecting, by the at least one first node, occurrence of a trigger event. The method may further comprise transmitting, by the at least one first node, a report based on the at least one parameter to at least one second node using one of physical layer and Media Access Control (MAC) layer.

In an aspect, the at least one RS is a sounding reference signal (SRS).

In an aspect, the parameter is at least one of Reference Signal Received Power (RSRP), Received Signal Strength Indicator (RSSI), Signal to Noise Ratio (SNR), Signal to Interference plus Noise Ratio (SINR), interference, and Reference Signal Received Quality (RSRQ).

In an aspect, the report comprises values of at least one of RSRP, RSSI, SNR, SINR, interference, and RSRQ.

In an aspect, the trigger event is one of an implicit trigger and an explicit trigger.

In an aspect, the implicit trigger is the value of the at least one parameter exceeding a threshold.

In an aspect, the threshold is configured by the at least one second node.

In an aspect, the threshold is one of at least one value and at least one range of values.

In an aspect, the threshold comprises a hysteresis value.

In an aspect, the threshold is defined in terms of one of an absolute power, amplitude, and relative power.

In an aspect, the occurrence of the trigger event is detected using a configuration for reporting. The configuration comprises at least one of an indication for dynamic reporting, a type of reporting, the trigger event, and scheduling for reporting.

In an aspect, the configuration is provided by the at least one second node to the at least one first node.

In an aspect, the type of reporting comprises at least one of periodic, semi-persistent, and aperiodic.

In an aspect, the scheduling for reporting comprises at least one of time resource, frequency resource, and periodicity.

In an aspect, the configuration is transmitted in at least one of Medium Access Control (MAC), Downlink Control Information (DCI), and Radio Resource Control (RRC) signaling.

In an aspect, in the aperiodic reporting, the at least one first node reports once to the at least one second node.

In an aspect, in the semi-persistent reporting, the at least one first node periodically transmits the report to the at least one second node.

In an aspect, in the semi-persistent reporting, the at least one first node stops reporting when an indication to stop reporting is received from the at least one second node.

In an aspect, in the semi-persistent reporting, the at least one first node periodically transmits the report to the at least one second node until the parameter becomes less than the threshold for at least one time unit.

In an aspect, the at least one time unit is defined in terms of one of a number of slots, a number of symbols, a number of frames, milliseconds, and seconds.

In an aspect, the at least one time unit is a measuring instance of the at least one parameter.

In an aspect, the at least one time unit is informed by the at least one second node to the at least one first node.

In an aspect, the at least one first node indicates the at least one second node that it has stopped reporting.

In an aspect, the report is transmitted through one of Physical Uplink Control Channel (PUCCH) and Physical Uplink Shared Channel (PUSCH).

In an aspect, transmitting the report comprises transmitting, by the at least one first node, a Scheduling Request (SR) to the at least second node, receiving, by the at least one first node, a grant from the at least one second node in form of uplink resources to be used, and transmitting, by the at least one first node, the report in the uplink resources provided by the at least one second node.

In an aspect, the at least one first node transmits an indication about the report to the at least one second node.

In an aspect, the report is transmitted in an at least one resource configured by the at least one second node.

In an aspect, the indication about the report comprises an information about an at least one resource for transmission of the report.

In an aspect, the information about the at least one resource is an identity of the at least one resource from a plurality of resources configured by the at least one second node.

In an aspect, the report is transmitted at least one time unit after transmitting the indication.

In an aspect, the at least one time unit is defined in terms of one of a number of slots, a number of symbols, a number of frames, milliseconds, and seconds.

In an aspect, the report is transmitted at least one time unit after measurement.

In an aspect, the report is transmitted at least one time unit after detection.

In an aspect, the at least one time unit depends on the capability of the at least one first node.

In an aspect, the at least one time unit is reported by the at least one first node to the at least one second node.

In an aspect, the at least one time unit is defined in terms of one of a number of slots, a number of symbols, a number of frames, milliseconds, and seconds.

In an aspect, the report is transmitted from the at least one first node in a same UL resource.

In an aspect, the explicit trigger is transmitted by the at least one second node.

In an aspect, the explicit trigger is transmitted in one of Medium Access Control (MAC) and Downlink Control Information (DCI).

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates a wireless communication system for communication between base stations and user Equipments (UEs) and interference in the system, in accordance with prior-art.

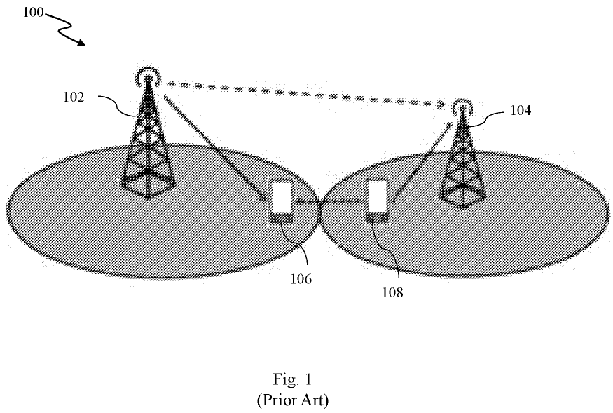

FIG. 2 illustrates transmission and reception boundaries of the SRS symbol for UEs, in accordance with prior art.

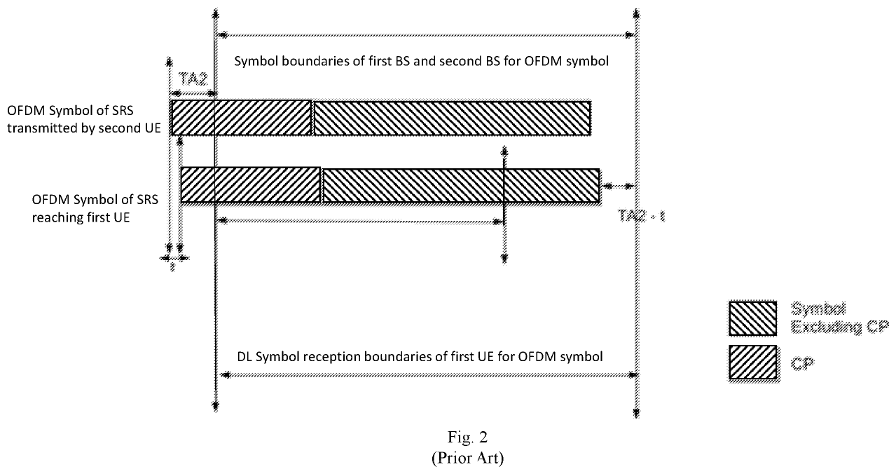

FIG. 3 illustrates a flow chart of a method for managing cross-link interference in a wireless communication network, in accordance with an embodiment of the present invention.

FIG. 4 illustrates a process of generating SRS resource symbols to be transmitted to a UE, in accordance with an embodiment of the present invention.

FIG. 5 illustrates a flow chart of a method of reporting cross-link interference in a wireless communication network, in accordance with an embodiment of the present invention.

Embodiments of the present disclosure and their advantages are best understood by referring to the detailed description that follows. It should be appreciated that like reference numerals are used to identify like elements illustrated in one or more of the figures.

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

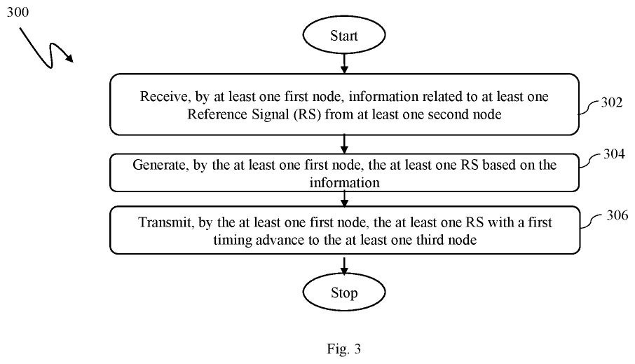

Present invention describes method of improving accuracy in Cross-Link Interference (CLI) measurement. The accuracy in the CLI measurement may be improved by avoiding loss of information included in Sounding Reference Signal (SRS) resource symbols of an SRS received at a UE. FIG. 3 illustrates a flow chart of a method for managing CLI in a wireless communication network, in accordance with an embodiment of the present invention. A first node, such as a first User Equipment (UE) may receive information related to a Reference Signal (RS), at step 302. The information related to may be received from a second node, such as a first Base Station (BS). The RS may be a Sounding Reference Signal (SRS). The information may be at least one of a phase rotation and a number of repetitions in time domain. The phase rotation may be configured such that time domain circularity is maintained over the plurality of time domain symbols in which the RS is transmitted. The information may be provided to the first UE using Radio Resource Control (RRC) message. The RRC message may be transmitted as SRS-Config Information Element (IE). The information may indicate the first UE to apply phase rotation on the SRS resource symbol.

The information may override hopping configuration provided by the first BS for the RS. The first BS may also indicate the first node to not apply hopping configuration for the RS. The hopping may comprise at least one of sequence hopping, group hopping, and frequency hopping.

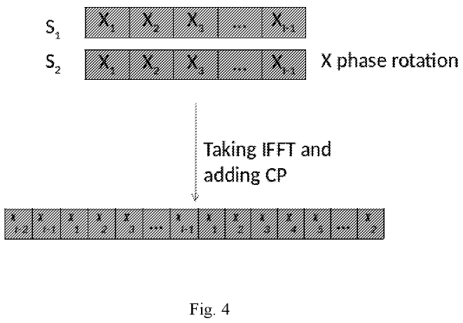

The first UE may generate the at least one RS based on the information, at step 304. The SRS resource symbols may include a plurality of Orthogonal Frequency Division Multiplexed (OFDM) symbols. The plurality of OFDM symbols may include a first OFDM symbol combined with a second OFDM symbol. The SRS resource symbols may be repeated over more than one OFDM symbol with a phase rotation such that a time domain circularity is maintained over all the plurality of OFDM symbols. Generation of the SRS resource symbols has been explained in detail successively with reference to FIG. 4.

As illustrated in FIG. 4, two OFDM symbols (a first OFDM symbol S1 and a second OFDM symbol S2) may be utilized to form the SRS resource symbols. The first OFDM symbol S1 and the second OFDM symbol S2 may have same SRS sequence. The phase rotation may be applied on the second OFDM symbol S2 using equation (1),

$${r}^{( {p}_{i} )} ( n , {l}^{′} ) = {r}_{u , v}^{( {α}_{i} , δ )} ( n ) \cdot {e}^{j 2 π Lnl ′ / N} \qquad ( 1 )$$

$$0 \leq n \leq {M}_{sc , b}^{SRS} - 1$$

$${l}^{′} ∈ \{ 0 , 1 , ... , {N}_{symb}^{SRS} - 1 \}$$

In above equation, r_(u,v)\hat{ }((α_i,δ)) (n) is the sequence, n is the index of each sample in the sequence, p_i is antenna port, δ is a parameter based on the transmission comb of SRS provided by the BS, l′ is the symbol number, L is the number of samples in CP, N is the discrete Fourier transform (DFT) size, u is sequence group, v is sequence number, α_i is cyclic shift, M_(“sc”,b)\hat{ }“SRS” is the number of sub-carriers (“sc”) occupied by SRS with frequency hopping number b, N_“symb” \hat{ }“SRS” is the number of consecutive SRS symbols.

Further, Inverse Fast Fourier Transform (IFFT) may be performed and Cyclic Prefix (CP) may be added on the first OFDM symbol S1 and the second OFDM symbol S2 to obtain phase rotated reference signals. The phase rotated reference signals may be combined together to obtain the SRS resource symbols. The time domain circularity may be maintained over the SRS resource symbols.

Referring back to FIG. 3, the first UE may transmit the RS, at step 306. The first BS may indicate the first UE to not apply sequence hopping, group hopping, or frequency hopping of the SRS resource symbols during generation of the SRS. Additionally, the first BS or a second BS may indicate the second UE to not apply a constant offset value while measuring the at least one RS.

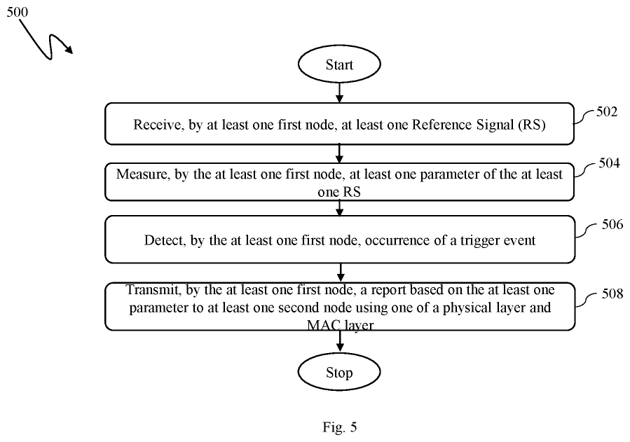

FIG. 5 illustrates a flow chart of a method of reporting the CLI in a wireless communication network, in accordance with an embodiment of the present invention. A first UE may receive the RS, at step 502. The first UE may measure the parameter of the RS, at step 504. The first UE may detect occurrence of a trigger event, at step 506. The first UE may transmit a report based on the parameter to a second node, such as a first BS, at step 508. The report may be transmitted to the first BS using layer 1 (physical layer) or layer 2 (MAC layer). The report may comprise Reference Signal Received Power (RSRP), Received Signal Strength Indicator (RSSI), Signal to Noise Ratio (SNR), Signal to Interference plus Noise Ratio (SINR), interference, and Reference Signal Received Quality (RSRQ).

The trigger event may be an implicit trigger or an explicit trigger. In the implicit trigger-based procedure, the first node may transmit the report only when a value of the parameter exceeds the threshold. The threshold may be provided by the second node. The threshold is one of at least one value, at least one range of values, and a hysteric value. The threshold may be defined in terms of one of an absolute power, amplitude, and relative power.

The occurrence of the trigger event is detected using a configuration for reporting, and wherein the configuration comprises an indication for dynamic reporting, a type of reporting, the trigger event, or scheduling for reporting. The configuration may be provided by the second node to the first node. The type of reporting may comprise periodic, semi-periodic, or aperiodic. An indication of semi-persistent reporting or non-periodic reporting may be received by the first node. In semi-persistent reporting, the first node may start reporting once the parameter exceeds the threshold until the first node receives an indication to stop from the second node. Therefore, even if the RSRP value falls below threshold at some instant after the first node has started transmitting the report, it will continue transmitting the report until the it receives an indication to stop by the second node.

The first node may continue periodic reporting until the RSRP value becomes less than the threshold at one or “N” multiple measuring instances. The measuring instances may be defined in terms of time units e.g. slots or time duration. For multiple measuring instances, “N” may be pre-defined or may be indicated by the second node. The first node may indicate the second node that the reporting has been stopped.

The first node may transmit reports through uplink resources, such as Physical Uplink Shared Channel (PUSCH) or Physical Uplink Control Channel (PUCCH). In an implementation, second node may configure the uplink resources for reporting of the RSRP of the SRS. In another implementation, the first node may transmit a scheduling request for allocation of the uplink resources. The second node may grant the uplink resources and the first node may periodically report the RSRP of the SRS to the second node through the uplink resources granted by the second node. The second node may further provide periodicity of reporting to the first node.

The first node may send a Scheduling Request (SR) for PUSCH resources to the second node. This SR may be specific to transmitting the report. The second node may provide a grant to the first node in the form of the UL resources and the first node may report the SRS-RSRP periodically in the scheduled UL resources provided by the second node in UL grant. Alternatively, the first node may send a request for UL control resources for transmitting the report. The second node may grant the request and may allocate the UL control resources to the first node for transmission of the report. The first node may transmit the report in the UL control resources periodically with the periodicity provided by the second node.

The first node may send an indication to send the report to the second node. The indication may be sent “N” time units/time duration before an actual transmission of the report. UL resources on which the report is to be sent is pre-configured by the second node. Along with the indication, the first node may also send information about the UL resources on which the report will be transmitted. The information may comprise a resource identity (ID) of an UL resource selected from a set of pre-configured UL resources provided by the second node. The report may be transmitted periodically in the UL resources configured by the second node. The periodicity may be provided by the second node.

The first node may not send the report if a duration between reception of SRS for measurement or detection of the trigger and an immediate available UL resource for sending the report is less than “K” time units/time duration. The first node may wait for the next available UL resource for transmitting the report.

The second node may multiplex several UEs at the same time-frequency resources for transmission of the report. The multiple UEs may be multiplexed using orthogonal sequences. However, since the reporting is trigger based, every UE may not transmit the report on configured resources simultaneously. The second node may configure which UEs are transmitting report on the configured resources.

In non-periodic reporting, the first node may transmit the report according to a configuration provided by the second node whenever the parameter exceeds the threshold. The RSRP may be reported only once and not periodically. The first node may send the report using PUSCH or PUCCH resources.

The second node may configure the uplink resources for transmitting the report. In another implementation, the first node may transmit a scheduling request for allocation of the uplink resources. The second node may grant the uplink resources and the first node may transmit the report to the second node through the uplink resources granted by the second node.

The first node may measure and transmit the report with a minimum time gap. Further, the first node may detect and transmit the report with the minimum time gap. The minimum time gap may depend on the capability of the first node. The minimum time gap may be reported by the first node to the second node.

The first node may send a request for UL control resources for transmission of the report. The second node may grant the request and may allocate the UL control resources to the first node for transmission of the report. The first node may send the report in the UL control resources.

The first node may send an indication for transmitting the report to the second node. The indication may be sent “N” time units/time duration before an actual transmission of the report. UL resources on which the report is to be sent is pre-configured by the second node. Along with the indication, the first node may also send information about the UL resources on which the report will be transmitted. The information may comprise a resource identity (ID) of an UL resource selected from a set of pre-configured UL resources provided by the second node. The report may be transmitted in the UL resources configured by the second node.

The first node may not send the report if a duration between reception of the RS for measurement and an immediate available UL resource for ending the report is less than “K” time units/time duration. The first node may wait for the next available UL resource for transmission of the report.

In the explicit trigger-based procedure, the second node may explicitly inform the first node on the time to transmit the report. The first node may transmit the report to the second node periodically, semi-persistently, or non-periodically. An indication of periodic reporting, semi-persistent reporting, or aperiodic reporting may be received by the first BS. In periodic reporting, the first node may transmit the report periodically according to parameters provided by the second node for the periodic reporting. The UL resources for sending the report may be provided by the second node.

In semi-persistent reporting, the first node may transmit the report periodically according to the parameters given by the second node. The first node may initiate reporting only when the second indicates the first node to report using Medium Access Control (MAC) or Downlink Control Information (DCI). The UL resources for sending the report may be provided by the second node. The UL resources may be provided using RRC, MAC, or DCI signaling. The reporting may be performed periodically after initiation until the second node indicates the first node to stop reporting. In an implementation, the first node may stop reporting when an indication to stop reporting is received from the second node. In another implementation, the first node may periodically transmit the report to the second node until the parameter becomes less than the threshold for a time unit. The time unit may be defined in terms of one of a number of slots, a number of symbols, a number of frames, milliseconds, and seconds.

In aperiodic reporting, the first node may transmit the report once to the second node when indicated by the second using MAC or DCI. The UL resources for sending the report may be provided by the second node. The UL resources may be provided using RRC, MAC, or DCI signaling.

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

1. A method for managing cross link interference in a wireless communication network, the method comprising:
receiving, by at least one first node, information related to at least one Reference Signal (RS) from at least one second node; wherein the information is at least one of a phase rotation and a number of repetitions in time domain;
generating, by the at least one first node, the at least one RS based on the information; and
transmitting, by the at least one first node, the at least one RS with a first timing advance.

2. The method as claimed in claim 1, wherein the at least one RS is a Sounding Reference Signal (SRS).

3. The method as claimed in claim 1, wherein the phase rotation is configured such that time domain circularity is maintained over a plurality of consecutive time domain symbols in which the at least one RS is transmitted.

4. The method as claimed in claim 1, wherein the information is received from the at least one second node, using Radio Resource Control (RRC) message.

5. The method as claimed in claim 4, wherein the RRC message is transmitted as SRS-config Information Element (IE).

6. The method as claimed in claim 1, wherein the at least one RS is repeated and trans-mitted in a same frequency resource over the plurality of consecutive time domain symbols without hopping.

7. The method as claimed in claim 1, wherein the at least one second node indicates the at least one first node not to apply hopping for the at least one RS.

8. The method as claimed in claim 6, wherein the hopping comprises at least one of sequence hopping, group hopping, and frequency hopping.

9. The method as claimed in claim 1, further comprising:
indicating by one of the at least one second node and at least one fourth node, to at least one third node to not apply a constant offset value while measuring the at least one RS.

10. A method for reporting cross link interference in a wireless communication network, the method comprising:
receiving, by at least one first node, at least one Reference Signal (RS);
measuring, by the at least one first node, at least one parameter of the at least one RS;
detecting, by the at least one first node, occurrence of a trigger event; and
transmitting, by the at least one first node, a report based on the at least one parameter to at least one second node using one of physical layer and Media Access Control (MAC) layer.

11. The method as claimed in claim 10, wherein the at least one RS is a sounding reference signal (SRS).

12. The method as claimed in claim 10, wherein the parameter is at least one of Reference Signal Received Power (RSRP), Received Signal Strength Indicator (RSSI), Signal to Noise Ratio (SNR), Signal to Interference plus Noise Ratio (SINR), interference, and Reference Signal Received Quality (RSRQ).

13. The method as claimed in claim 10, wherein the report comprises values of at least one of RSRP, RSSI, SNR, SINR, interference, and RSRQ.

14. The method as claimed in claim 10, wherein the trigger event is one of an implicit trigger and an explicit trigger.

15. The method as claimed in claim 14, wherein the implicit trigger is the value of the at least one parameter exceeding a threshold.

16. The method as claimed in claim 15, wherein the threshold is configured by the at least one second node.

17. The method as claimed in claim 15, wherein the threshold is one of at least one value and at least one range of values.

18. The method as claimed in claim 15, wherein the threshold comprises a hysteresis value.

19. The method as claimed in claim 15, wherein the threshold is defined in terms of one of an absolute power, amplitude, and relative power.

20. The method as claimed in claim 10, wherein the occurrence of the trigger event is detected using a configuration for reporting, and wherein the configuration comprises at least one of
an indication for dynamic reporting,
a type of reporting,
the trigger event, and
scheduling for reporting.

21. The method as claimed in claim 20, wherein the configuration is provided by the at least one second node to the at least one first node.

22. The method as claimed in claim 20, wherein the type of reporting comprises at least one of periodic, semi-persistent, and aperiodic.

23. The method as claimed in claim 20, wherein the scheduling for reporting comprises at least one of time resource, frequency resource, and periodicity.

24. The method as claimed in claim 20, wherein the configuration is transmitted in at least one of Medium Access Control (MAC), Downlink Control Information (DCI), and Radio Resource Control (RRC) signaling.

25. The method as claimed in claim 22, wherein in the aperiodic reporting, the at least one first node reports once to the at least one second node.

26. The method as claimed in claim 22, wherein in the semi-persistent reporting, the at least one first node periodically transmits the report to the at least one second node.

27. The method as claimed in claim 22, wherein in the semi-persistent reporting, the at least one first node stops reporting when an indication to stop reporting is received from the at least one second node.

28. The method as claimed in claim 22, wherein in the semi-persistent reporting, the at least one first node periodically transmits the report to the at least one second node until the parameter becomes less than the threshold for at least one time unit.

29. The method as claimed in claim 28, wherein the at least one time unit is defined in terms of one of a number of slots, a number of symbols, a number of frames, milliseconds, and seconds.

30. The method as claimed in claim 28, wherein the at least one time unit is a measuring instance of the at least one parameter.

31. The method as claimed in claim 28, wherein the at least one time unit is informed by the at least one second node to the at least one first node.

32. The method as claimed in claim 28, wherein the at least one first node indicates the at least one second node that it has stopped reporting.

33. The method as claimed in claim 10, wherein the report is transmitted through one of Physical Uplink Control Channel (PUCCH) and Physical Uplink Shared Channel (PUSCH).

34. The method as claimed in claim 10, wherein transmitting the report comprises:
transmitting, by the at least one first node, a Scheduling Request (SR) to the at least second node;
receiving, by the at least one first node, a grant from the at least one second node in form of uplink resources to be used; and
transmitting, by the at least one first node, the report in the uplink resources provided by the at least one second node.

35. The method as claimed in claim 10, wherein the at least one first node transmits an indication about the report to the at least one second node.

36. The method as claimed in claim 35, wherein the report is transmitted in an at least one resource configured by the at least one second node.

37. The method as claimed in claim 35, wherein the indication about the report comprises an information about an at least one resource for transmission of the report.

38. The method as claimed in claim 37, wherein the information about the at least one resource is an identity of the at least one resource from a plurality of resources configured by the at least one second node.

39. The method as claimed in claim 35, wherein the report is transmitted at least one time unit after transmitting the indication.

40. The method as claimed in claim 39, wherein the at least one time unit is defined in terms of one of a number of slots, a number of symbols, a number of frames, milliseconds, and seconds.

41. The method as claimed in claim 10, wherein the report is transmitted at least one time unit after measurement.

42. The method as claimed in claim 10, wherein the report is transmitted at least one time unit after detection.

43. The method as claimed in claim 41 and claim 42, wherein the at least one time unit depends on the capability of the at least one first node.

44. The method as claimed in claim 41 and claim 42, wherein the at least one time unit is reported by the at least one first node to the at least one second node.

45. The method as claimed in claim 41 and claim 42, wherein the at least one time unit is defined in terms of one of a number of slots, a number of symbols, a number of frames, milliseconds, and seconds.

46. The method as claimed in claim 10, wherein the report is transmitted from the at least one first node in a same UL resource.

47. The method as claimed in claim 15, wherein the explicit trigger is transmitted by the at least one second node.

48. The method as claimed in claim 47, wherein the explicit trigger is transmitted in one of Medium Access Control (MAC) and Downlink Control Information (DCI).
